(19) United States
(12) Patent Application Publication
(10) Pub. No.: US 2007/0264172 A1
(43) Pub. Date: Nov. 15, 2007

(54) DEVICE FOR PRODUCING SOOT

(75) Inventors: Thomas Mosimann, Meisterschwanden (CH); Markus Kasper, Widen (CH)

Correspondence Address: RANKIN, HILL, PORTER & CLARK LLP, 38210 Glenn Avenue, WILLOUGHBY, OH, 44094-7808, US

(73) Assignee: MATTER ENGINEERING AG, Wohlen (CH)

(21) Appl. No.: 11/695,399

(22) Filed: Apr. 2, 2007

(30) Foreign Application Priority Data
Apr. 6, 2006 (EP) 06405149.3

(51) Int. Cl. C09C 1/48

(52) U.S. Cl. 422/150; 23/314

(57) ABSTRACT

The method, and device for carrying out the method, for producing soot with defined characteristics for measurement or calibration purposes, contains the method steps of supplying fuel gas and oxidation gas (1, 2) into a combustion chamber (4), bringing the fuel gas and oxidation gas to react in the combustion chamber (4), so that a flame (3) arises, setting flow conditions in the combustion chamber (4), so that a gas flow in the flame (3) runs in a non-turbulent manner, and supplying cooling and dilution gas (5) into the combustion chamber (4) downstream of the flame (3) with respect to the flow direction. A soot discharge conduit separate from the combustion chamber (4) becomes superfluous on account of the procedure according to the invention.

### BACKGROUND OF THE INVENTION

1. Field of the Invention

The invention relates to a device for producing soot with reproducible characteristics.

2. Description of Related Art

Soot producers, which produce soot with reproducible characteristics, are required for the calibration or adjustment of soot particle measurement apparatus. Such soot particle measurement apparatus are for example applied for measuring emission characteristics of combustion motors, in particular diesel motors. A further important field of application for soot producers is the development and testing of the most different types of filters, for whose characterisation one must prepare dusts or soot aerosols with known, constant and, as the case may be, adjustable possibilities. Soot producers represent an inexpensive alternative to motor test beds in such applications.

One possibility of soot production is based on combustion in a flame. So that the characteristics of the soot may be reproduced as desired, no turbulences should occur. This is in contrast to soot producers which should produce large quantities of soot. As is known, turbulences have the result of larger soot quantities being produced in a more or less intermittent manner. The flame therefore, for the present purpose, should be a diffusion flame or a premixed flame, and the flows in the region of the flame are to be kept more or less laminar.

Such soot producers are described in the documents EP 1 055 877 and WO 2004/065494. A diffusion flame producing soot particles is formed in the combustion chamber by way of a fuel gas and an oxidation gas. The combustion chamber runs into a conduit separate therefrom, in which extinguishing gas is supplied, and in which the soot particles are led away. Due to the construction with a separate soot discharge conduit, one succeeds in changes of the flow conditions in the soot discharge conduit having no noticeable influence on the characteristics of the produced soot particles.

The previously mentioned soot producers have the common disadvantage that they are relatively complicated in construction. Devices with pipes running laterally into one another are quite complicated to manufacture.

### BRIEF SUMMARY OF THE INVENTION

It is the therefore the object of the invention to provide a device and a method for producing soot particles with reproducible characteristics, which overcomes the disadvantages of existing devices and methods, and in particular is to permit the formation of soot with settable characteristics. The device should preferably be simpler to manufacture than devices according to the state of the art.

The object is achieved by the invention as is defined in the patent claims.

With the device according to the invention, downstream of the flame with respect to the flow direction, a cooling and dilution gas is supplied to the combustion chamber in which a flame is formed in a non-turbulent flow environment. With the preferably selected geometry with a vertically upwardly directed flame (similar to a candle flame), “downstream of the flame” is to be equated with “above the flame”.

In this text, relative details with regard to location and direction such as “above”, “below”, “vertical”, “lateral” etc. are always to be understood in relation to the operating condition.

The state of the art according to EP 1 055 877 and WO 2004/065494 teaches leading the gas containing soot particles out of the combustion chamber into a horizontally running soot discharge conduit, into which an extinguishing gas is also introduced. The gas flows in a vertical manner in the flame and, thus, in the combustion space. In contrast to this, according to the invention, a cooling and dilution gas is supplied directly to the combustion chamber, i.e. no mouth of one chamber into another chamber or conduit is located between the flame and the cooling and dilution gas supply. In the case of a construction of parts which are rotationally symmetrical about an axis (this is advantageous for the manufacture), there are no axes which are tilted with respect to one another, and neither is there a change in the flow direction between the combustion chamber and a soot discharge conduit, as is taught in the state of the art. A practically cylinder-symmetrical construction of a straight tube is possible, which forms the combustion chamber. This also simplifies the flow conditions and favours the reproducibility. Preferably, not even a narrowing or widening of the chamber is required between the flame and the cooling and dilution gas supply.

A further advantage of the procedure according to the invention in contrast to the state of the art is that no quenching gas needs to be used as a cooling and dilution gas (i.e. no gas such as nitrogen or a noble gas which are chemically inert at the prevailing temperatures), but one may, for example, also use air.

The flame runs in a non-turbulent flow. By way of this, the method is well suitable for manufacturing soot for measurement, calibration and test purposes. Indeed, it has been found that the coagulation is accelerated in a turbulent environment, which, on average, leads to larger soot particles. Since the measurement apparatus to be calibrated/tested, and filters, are to be sensitive to and effective for the noxious smaller particles respectively, an aerosol with larger soot particles, however, is not suitable for calibration and test purposes.

A device according to the invention is a soot producer for measurement, calibration, testing or filter-test purposes, with a combustion chamber and at least one nozzle or opening running into the combustion chamber, for supplying cooling and dilution gas.

The construction according to the invention is significantly simpler and therefore less expensive in manufacture than a soot producer according to the state of the art. Its design is also more flexible, but an essentially tubular body may be used as a combustion chamber. This permits the simple variation of parameters such as the vertical distance between the supply of the fuel gas and oxidation gas and the mouth of the cooling and dilution gas, between different examples of the soot producer according to the invention. The mentioned vertical distance essentially determines the region in which soot particles are formed, and in which they may react/coagulate with the environment. According to a special embodiment, this vertical distance may even be set by way of the supply of the fuel gas and oxidation gas and/or the mouth of the cooling and dilution gas being vertically displaceable with respect to the combustion chamber (i.e. along a flow axis).

The supply of the cooling and dilution gas is particularly preferable from several sides towards a middle of the combustion chamber. For example, the combustion chamber comprises at least three, preferably at least four, at least five, at least six or more inlets, which, for example, are arranged annularly around the middle, and through which the cooling or dilution gas flows towards the middle. The inlets may for example be openings or nozzles or combinations of these.

An embodiment in which the combustion chamber is designed as a straight tube, and with which the supply of the cooling or dilution gas is fed through several openings (holes) arranged annularly around the peripheral surface, is particularly favorable with regard to manufacturing technology.

### BRIEF DESCRIPTION OF THE DRAWINGS

Embodiment examples of the invention are hereinafter described in detail by way of drawings. In the drawings, there are shown in:

FIG. 1 a schematic diagram of the device according to the invention, for carrying out the method according to the invention,

FIG. 2 a schematic diagram of a further device according to the invention, for carrying out the method according to the invention.

### DETAILED DESCRIPTION OF THE INVENTION

The same reference numerals in the figures indicate elements of both embodiments which correspond to one another.

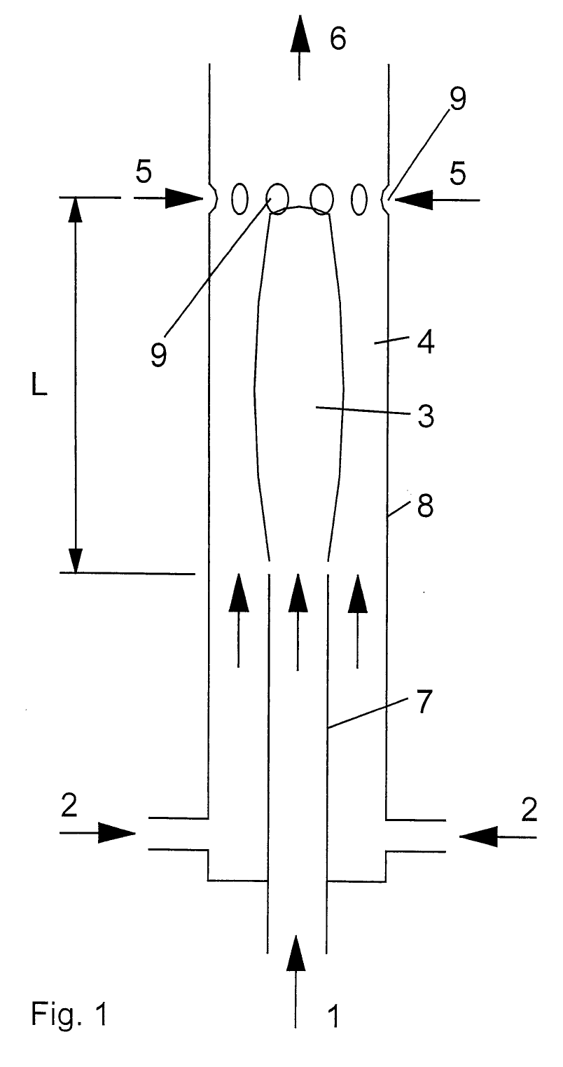

The soot producer according to FIG. 1 comprises a combustion chamber tube 8 by way of which the wall of the combustion chamber is formed. A fuel gas tube 7 through which a fuel gas 1 may be supplied to the combustion chamber, leads into the inside of the combustion chamber. An oxidation gas 2 may be supplied through further supply openings into a lower region of the combustion chamber 4. A diffusion flame 3 may be maintained in the combustion chamber 4 with a simultaneous supply of fuel gas and oxidation gas and after prior ignition.

In the shown arrangement, the fuel gas tube 7 projects into the combustion chamber, whilst the oxidation gas is supplied further below in the flow direction. As shown, in this arrangement, the diffusing flame 3 forms upwards from the mouth of the fuel gas tube 7. A cooling and dilution gas is supplied 5 to the combustion chamber in the flow direction above the mouth of the fuel gas tube 7. This is effected through openings 9 in the wall of the combustion chamber. These opening 9 are arranged distributed in an annular arrangement along a peripheral line of the wall. By way of this, cooling and dilution gas flows from openings lying opposite one another (or roughly opposite ones) into the combustion chamber 4 from opposite horizontal directions, so that the resulting contribution to the flow by way of the supply of the cooling and dilution gas approximately disappears in the horizontal direction. In its sum, an essentially vertical gas flow also forms in the flow direction above the supply of the cooling or dilution gas.

The volume flows of the fuel gas and oxidation gas, and, as the case may be, of admixed further gases, are maintained such that a laminar flow results in the region of the flame.

The volume flow of the cooling and dilution gas is selected so high, that the flame is cooled to such an extent by way of this, that it is extinguished and the oxidation of the soot particles is prevented. The volume flow may be selected depending on the chemical composition of the cooling and dilution gas. If, which is particularly simple, air is selected as a cooling- and dilution gas, the stoppage/prevention of the oxidation process is primarily effected by the cooling effect. When using inert extinguishing gas, the great dilution of the oxygen content by way of the extinguishing gas also counteracts the oxidation process.

The soot-containing aerosol 6 flows upwards out of the combustion chamber 4, where it may be transported further as directed by way of suitable transport and/or conveying means (not drawn), for example by way of further transport pipes or flexible tubes.

The height of the flame is determined by the vertical distance L between the fuel gas tube mouth and the openings 9. The fuel gas tube 7 may for example be displaceable relative to the combustion chamber tube 8, and the flame height L may be varied by way of this. By way of this, the soot particle size and the soot particle concentration as well as the soot particle mass discharge may be influenced in a targeted manner. Further influencing possibilities result by way of other gases, such as nitrogen or air, being able to be admixed to the fuel gas 1 and/or to the oxidation gas 2.

In the drawn arrangement, the fuel gas is supplied through a separate fuel tube 7 with a mouth in the combustion space, whilst the oxidation gas flows from below externally along the fuel tube 7. A reverse configuration is also conceivable, i.e. the oxidation gas flows through a separate tube, whilst the fuel gas flows along this on the outside. It is also possible for the fuel gas as well as the oxidation gas to be led to the base of the flame 3 in a targeted manner, for example, by way of them flowing through two tubes which are concentric or parallel to one another and run in next to one another.

An arrangement with a pre-mixed fuel gas and oxidation gas is also conceivable.

The combustion chamber 4 may be surrounded or partly surrounded by an outer chamber (not drawn). This outer chamber then encompasses the combustion chamber at least in the region of the openings. The outer chamber contains the cooling and dilution gas with a higher pressure than prevails in the combustion chamber. The outer chamber may be formed by an external tube, which encompasses the combustion chamber tube at least in regions. It may, for example, also be present an annular sleeve, which is applied around the combustion chamber tube at the height of the openings 9. Many further solutions are conceivable.

There exist applications with which the aerosol 6 may also be made available at a pressure lying below the atmospheric pressure. An example of this is the arrangement shown in the document WO 2006/005 212 of Matter Engineering. An outer chamber is not necessary for such applications. Rather, by way of suitable pump means, one may ensure that an underpressure always prevails in the combustion chamber 4. The surrounding air may serve as a cooling and dilution gas, which is then automatically sucked through the opening 9.

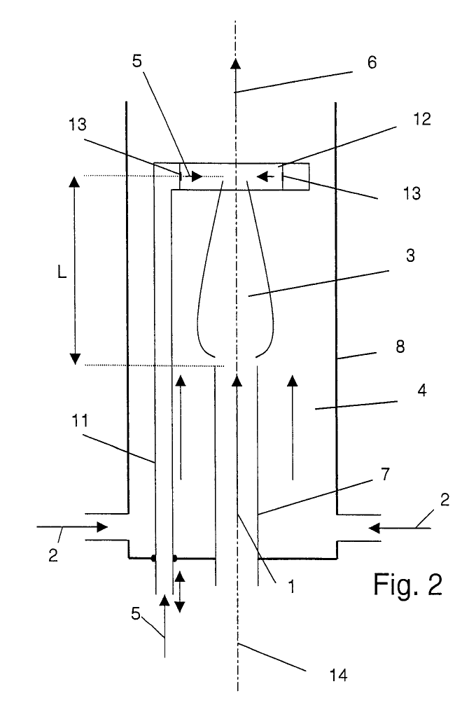

A further embodiment of a soot producer according to the invention is shown in FIG. 2. Only those elements whose functioning differs from those of the embodiment according to FIG. 1 are described. In contrast to the latter, the cooling and dilution gas is not supplied through openings in the wall of the combustion space 4, but through nozzles 12 which are arranged on the inner side on a cooling gas ring 12. The cooling gas ring is, for example, concentric with the combustion chamber 4 (axis 14 of the combustion chamber and of the cooling gas ring). Two or more nozzles 13 may be present and, for example, may be uniformly distributed along the inner side of the cooling gas ring. The supply into the cooling gas ring is effected through the cooling gas tube 11. The cooling gas ring, as indicated by a double arrow, is for example axially displaceable relative to the combustion space, by which means the height L of the flame 3 may be influenced. Of course, as an alternative or supplementary to this, the fuel gas tube 7 may also be displaceable with respect to the combustion space 4.

Many further embodiments are conceivable without departing from the scope and spirit of the invention.

1. A method for producing soot with defined characteristics, for measurement, calibration, test, or filter-testing purposes, comprising the steps of:
supplying fuel gas and oxidation gas into a combustion chamber,
bringing the fuel gas and oxidation gas to react in the combustion chamber, so that a flame arises,
setting flow conditions in the combustion chamber, so that a gas flow in the flame runs in a non-turbulent manner, and
supplying a cooling and dilution gas to the combustion chamber, downstream of the flame with respect to a flow direction.

2. The method according to claim 1, wherein the cooling and dilution gas is supplied to the combustion chamber from several sides, and is emitted towards a middle.

3. The method according to claim 2, wherein the cooling cooling and dilution gas is supplied to the combustion chamber from at least three inlets, each of the at least three inlets being a nozzle or an opening.

4. The method according to claim 3, wherein the inlets are arranged annularly around a middle.

5. The method according to claim 3, wherein the inlets are openings in a wall of the combustion chamber.

6. The method according to claim 1, wherein said cooling cooling and dilution gas is air.

7. The method according to claim 6, wherein the air is chosen to be at room temperature.

8. A device for producing soot with defined characteristics for measurement, calibration, test, or filter-testing purposes, comprising
a combustion chamber in which a flame may be formed,
a supply into the combustion chamber, for fuel gas and oxidation gas, for forming the flame,
wherein flow conditions in the combustion chamber in an operating condition of the device are set such that a gas flow in the flame runs in a non-turbulent manner, and
further comprising at least one inlet for supplying a cooling and dilution gas into the combustion chamber, said at least one inlet being arranged downstream of the flame with respect to a flow direction.

9. The device according to claim 8, wherein said at least one inlet includes a plurality of inlets for the supply of cooling and dilution gas from different directions.

10. The device according to claim 8, wherein said at least one inlet includes at least one of an opening or a nozzle.

11. The device according to claim 9, comprising at least three inlets arranged downstream of the flame annularly around a middle, such as to emit the cooling and dilution gas towards the middle in an operating condition.

12. The device according to claim 11, where each one of said at least three inlets is either an opening or a nozzle.

13. The device according to claim 8, wherein the inlet is designed as a hole in a wall of the combustion chamber, and wherein an environment gas flows through this hole into the combustion chamber in the operating condition, and thereby acts as the cooling and dilution gas.

14. The device according to claim 13, further comprising an outer chamber which surrounds the combustion chamber at least in the region of the hole in the wall, the outer chamber containing the environment gas.

15. The device according to claim 8, wherein a distance (L) between the supply for fuel gas and oxidation gas, and the at least one inlet is tunable.
